(19) United States
(12) Patent Application Publication
(10) Pub. No.: US 2017/0316404 A1
(43) Pub. Date: Nov. 2, 2017

(54) DIGITAL MARKETPLACE FOR CASINO APPLICATIONS

(71) Applicant: BETCADE LLC, San Mateo, CA (US)

(72) Inventors: David Barbarino Chang, San Mateo, CA (US); Trevor Alan Fiatal, Fremont, CA (US)

(21) Appl. No.: 15/485,021

(22) Filed: Apr. 11, 2017

Related U.S. Application Data
(63) Continuation of application No. 15/096,197, filed on Apr. 11, 2016.
(60) Provisional application No. 62/321,169, filed on Apr. 11, 2016.
(60) Provisional application No. 62/145,432, filed on Apr. 9, 2015.

(51) Int. Cl. G06Q 20/36; G07F 17/32; G06F 3/0482; G06Q 20/10; G06Q 30/02

(52) U.S. Cl. CPC G06Q 20/3672; G07F 17/3255; G07F 17/3244; G07F 17/3225; G06F 3/0482; G07F 17/3223; G06Q 20/102; G06Q 30/0207

(57) ABSTRACT

The disclosed technology is directed at an application marketplace for aggregating real-money casino applications for Android, iOS, Windows Mobile, and any other mobile ecosystem. The marketplace moderates and manages promotions and operations of casino applications, for example, in connection with live events, offers, casino offers. The marketplace additionally manages actual money or digital chips in a shared digital wallet. The marketplace incorporates a system for making in-application deposits, with consistent access to stored payment methods across casino applications and centralized access to billing transaction records. The marketplace links a store application or website to an embedded software element (SDK) within third-party casino applications which facilitates both application management and deposit of funds into casino applications. The marketplace personalizes user experience in ways specific to gambling based on declared preferences, observed consumer behavior, and individual or cohort deposit patterns within and across casino applications or categories of casino applications.

### CROSS-REFERENCE TO RELATED APPLICATIONS

This application claims priority to U.S. Provisional Patent Application No. 62/321,169 filed Apr. 11, 2016, which is incorporated herein by reference in its entirety. This application is a continuation application of U.S. patent application Ser. No. 15/096,197, filed Apr. 11, 2016, which claims priority to Provisional Application No. 62/145,432, filed Sep. 9, 2015, both of which are incorporated herein by reference in their entirety.

### INCORPORATION BY REFERENCE

The following disclosures are incorporated by reference in their entirety and for all purposes to the same extent as if the patent application was specifically reprinted in this specification: United States Patent U.S. patent application Ser. No. 10/988,304, filed Nov. 12, 2004, titled “System and Method for Downloading or Enabling Download of a Program from a Program Store Location;” U.S. patent application Ser. No. 13/495,571, filed Jun. 13, 2012, titled “Enterprise Mobile Application Store;” U.S. Pat. No. 8,832,817, filed Jul. 19, 2012, titled “Application Marketplace Administrative Controls;” and U.S. Pat. No. 7,802,294, filed Jan. 28, 2005, titled “Controlling Computer Applications' Access to Data.”

### TECHNICAL FIELD

The disclosed technology relates generally to the management and distribution of mobile applications. More specifically, the disclosed technology relates to the management of currency between a plurality of gambling applications.

### BACKGROUND

Smartphones or modern cell phones often include mobile applications. Mobile applications are purchased, managed, and updated by marketplace or store application. Present marketplace applications disallow casino applications and are accordingly not structured to accommodate such applications. Therefore there is a need for an application marketplace which manages casino applications.

### INCORPORATION BY REFERENCE

The following disclosures are incorporated by reference in their entirety and for all purposes to the same extent as if the patent application was specifically reprinted in this specification: United States Patent U.S. patent application Ser. No. 10/988,304, filed Nov. 12, 2004), titled “System and method for downloading or enabling download of a program from a program store location;” U.S. patent application Ser. No. 13/495,571, filed Jun. 13, 2012, titled “Enterprise mobile application store;” U.S. Pat. No. 8,832,817, filed Jul. 19, 2012, titled “Application marketplace administrative controls;” and U.S. Pat. No. 7,802,294, filed Jan. 28, 2005, titled “Controlling computer applications' access to data.”

### SUMMARY

Embodiments of the disclosed technology are directed at an application marketplace (or, a casino marketplace) for aggregating casino applications for Android, iOS, Windows Mobile, and any other mobile ecosystem. The marketplace moderates and manages promotions and operations of casino applications. In some embodiments, the marketplace additionally manages actual money or digital chips in a shared digital wallet.

### BRIEF DESCRIPTION OF THE DRAWINGS

Embodiments of the present technology will be described and explained through the use of the accompanying drawings in which:

FIG. 1 is an example diagram of a marketplace application network configuration;

FIG. 2 is a flowchart illustrating a method of operation for a casino marketplace;

FIG. 3 is a flowchart illustrating a method of promoted casino applications;

FIGS. 4-7 are example sequence diagrams illustrating process flows of methods of operation for various embodiments of the casino marketplace;

FIGS. 8A-8C illustrate example screenshots depicting bets on real life events in real time in accordance with various embodiments of the casino marketplace;

FIGS. 9A-9B illustrate example screenshots depicting segments of the casino marketplace and promotions associated with the segments in accordance with various embodiments of the casino marketplace;

FIGS. 10A-10D illustrate example screenshots depicting mechanisms for resetting a pin associated with a user's account in accordance with various embodiments of the casino marketplace;

FIGS. 11A-11C illustrate example screenshots depicting promotion codes for time-based promotions in accordance with various embodiments of the casino marketplace;

FIG. 12 illustrates an example screenshot depicting a user's casino marketplace account;

FIGS. 13A-13D illustrate example screenshots depicting a user's preferences and casino applications associated with sport events in accordance with various embodiments of the casino marketplace; and

FIG. 14 illustrates an example of a computer system with which some embodiments of the present disclosure may be utilized

### DETAILED DESCRIPTION

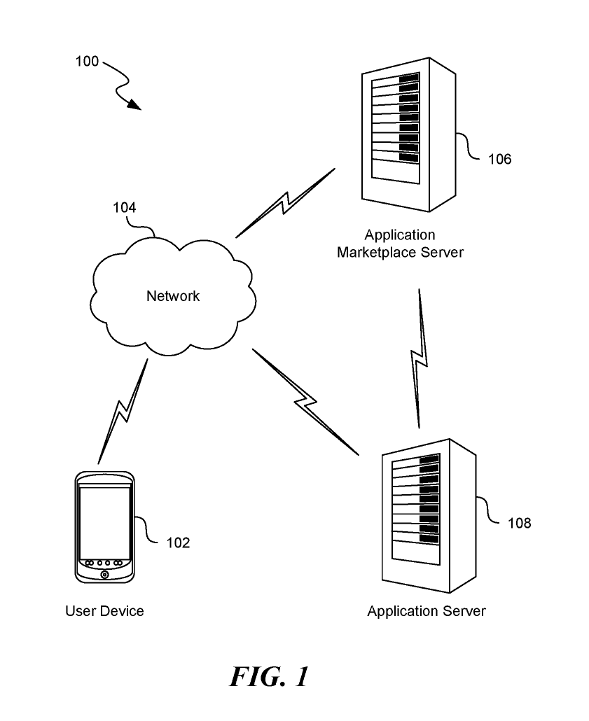

FIG. 1 is a diagram of a marketplace application network configuration 100. Users have mobile devices 102 which communicate with a network 104 such as the Internet. To obtain a marketplace app (also referred to herein as “marketplace”), a user directs a mobile device 102 to download the marketplace. Alternatively, the user makes use of a computer to first download the marketplace and then transfers the marketplace to the user's mobile device 102 for installation. The marketplace software is supported by a marketplace server 106 which communicates with the mobile device 102 via the Internet. The marketplace application is alternatively referred to herein as the casino marketplace.

Through use of the marketplace, the mobile device 102 communicates with application servers 108. Application servers 108 support casino application software (“casino apps”). Mobile devices 102 in communication with marketplace application servers 106 request casino apps from application servers 108 which are loaded onto the mobile device 102. Marketplace application servers 106 (also referred to herein as marketplace servers) provide updates to casino software as available to the mobile device 102. For example, application servers 108 can be owned and operated by gaming companies or casinos. In some embodiments, application servers 108 are owned and operated by the same entity that owns and operates the marketplace server 106. Embodiments disclosed herein provide, among others, the functionality of a payment processor, eliminating the need for any intermediary clearinghouse or intermediary financial processor. This results in an enhanced user experience because the marketplace app on the user's mobile device, application servers 108, and/or marketplace application servers 106 not only provide the casino apps but is also involved in processing payments for the casino apps without requiring intermediary payment processing systems.

The marketplace app includes a user interface on the mobile device 102 for presenting one or more casino apps to the user of the mobile device 102. The casino apps can be downloaded or can be already existing on the mobile device 102. In some embodiments, a casino app existing on the mobile device 102 may be accessed solely via the casino app. In some embodiments, the marketplace provides functionality for the mobile device 102 to execute the casino app from within the marketplace app.

In some embodiments, application servers 108 provide their casino apps to the marketplace application servers 106 for download. In other embodiments, the marketplace application servers 106 scans the Internet for available casino apps and makes these casino apps available for download to mobile devices 102. Thus, the marketplace app is an aggregator for one or more casino apps. In some embodiments, the marketplace app also provides information related to promotions and operations of casino applications, for example, in connection with live events, offers, casino offers.

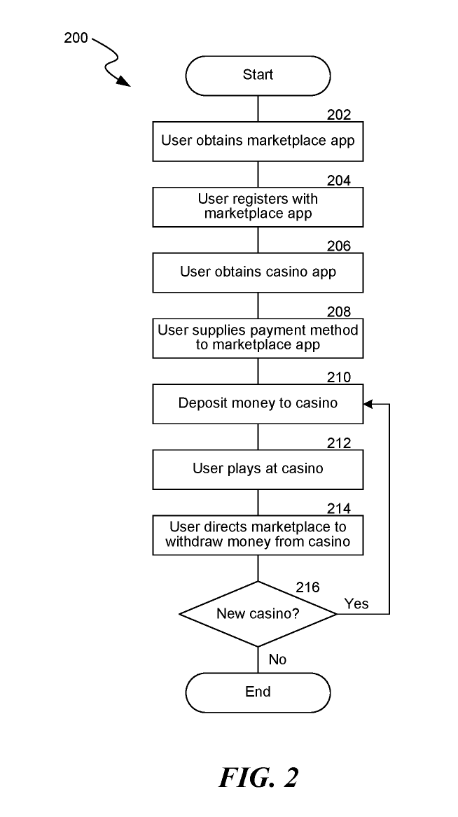

FIG. 2 is a flowchart illustrating a method of operation 200 for a casino marketplace. At step 202, a user obtains the marketplace. The user registers an account with the marketplace at step 204. Account registration requires identifying information such as a credit card, a third party social account, an email address, or any other identifying information that is enabled to be verified out of band. Once a user is registered with the marketplace, the user obtains (at step 206) one or more casino applications from the marketplace. The user supplies (at step 208) a verified payment method to the marketplace. The marketplace uses (at step 210) this payment method to process payments for immediate deposit into one or more digital wallets held by the casinos in the user's name. In some embodiments, a user also supplies a monetary deposit along with the payment method. The monetary deposit can be processed through means including but not limited to standard debit/credit transactions, electronic bank drafts, third-party alternative payment services, or through a transfer from another digital wallet.

According to one embodiment, after the user has money on the marketplace, the user chooses a casino where to send the money. The marketplace server communicates with the application server and indicates the presence of funds in the user's name. The user is enabled to play games at that casino with the indicated funds. When the user spends (at step 212) a portion or all of the funds at the casino, the marketplace server deposits the appropriate funds in an account at the application server's direction. In some embodiments, the marketplace retains a transaction fee from the funds before depositing the funds at the direction of the application server.

In another embodiment, when the user has finished playing games at the casino, the user directs (at step 214) any remaining funds to be transferred from the casino and back into the marketplace account. In the event where the user has obtained more funds than the user began with, the marketplace requests funds from an account the application server indicates. In some embodiments, the marketplace server retains a transaction fee from the requested funds.

In some embodiments, the user can direct (at step 216) funds to be transferred from the marketplace account to a different casino. In this way, the marketplace treats the individual casino applications as if each were a “table” in a physical casino that the user may “sit down” and “get up from” at will.

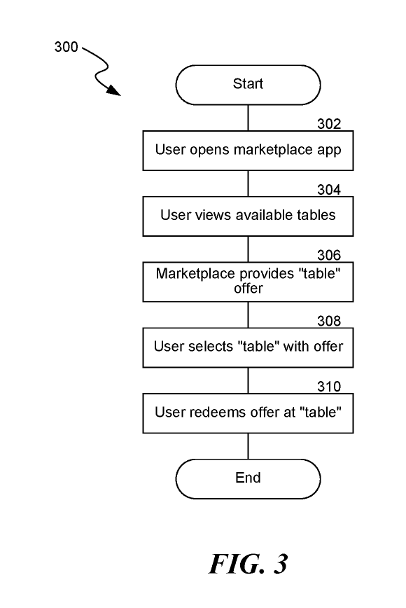

FIG. 3 is a flowchart illustrating a method of promoted casino applications 300. The disclosed technology enables users to make use of a secondary kind of currency referred to herein as chips. In some embodiments, chips function as money. However, chips may not be collectable as money until a chip has first been bet at a casino. In some embodiments, users are enabled to buy chips directly from the marketplace and use the chips instead of money.

In some embodiments, chips can be associated with gaming rules. For illustrative purposes, if a game normally pays 2:1, a user who bets chips can, instead of money, receive a 3:1 payment in chips. Thus, in some embodiments, using chips can modify the gaming rules of a casino.

In some embodiments, a third kind of currency (referred to herein as tokens) for playing casino apps is available. In some embodiments, tokens have no monetary value and can be used with zero monetary risk and zero monetary reward method of playing at casino apps.

In use, a user first opens the marketplace on the mobile device at step 302. The user views available casino apps or “tables” the user has accessible on the mobile device at step 304. In some embodiments, the marketplace provides a promotional offer to one or more of the tables at step 306. Promotional offers can include free or discounted chips at one or more casino apps. In some embodiments, promotional offers comprise additional special rules applied to chips that do not apply at other casino apps.

A user selects (at step 308) a casino or “table” 308 and redeems (at step 310) the promotional offer by satisfying the conditions of the offer at the casino. The marketplace manages promotional offers with partner agreements with the casino apps. Partner agreements comprise adjusted transaction fees in return for additional exposure of the casino apps in the marketplace. In some embodiments promotional offers are unilaterally controlled by the marketplace.

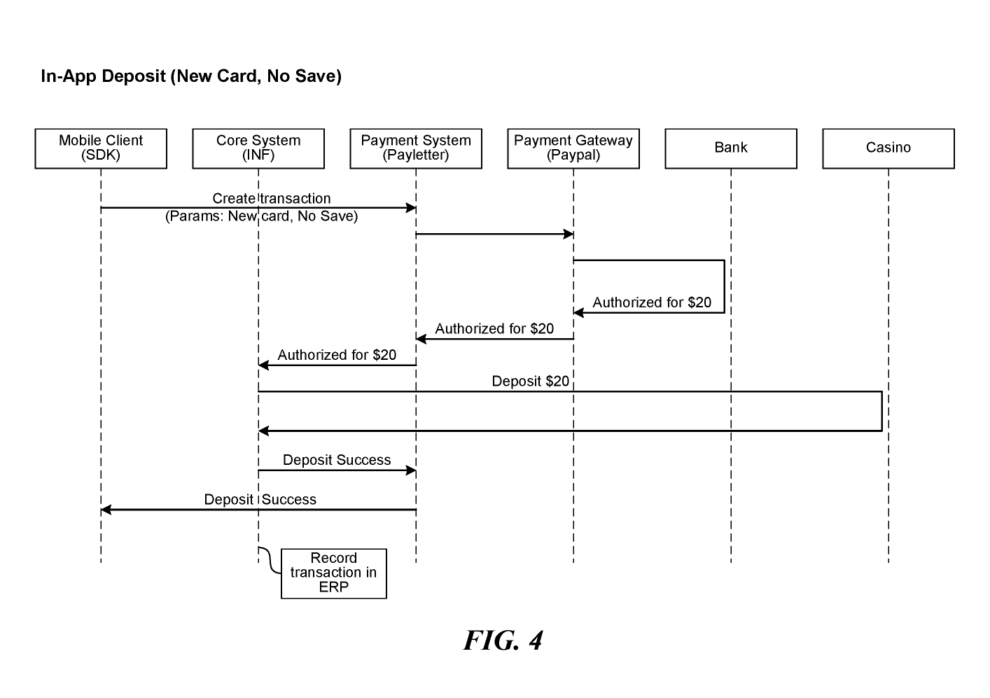

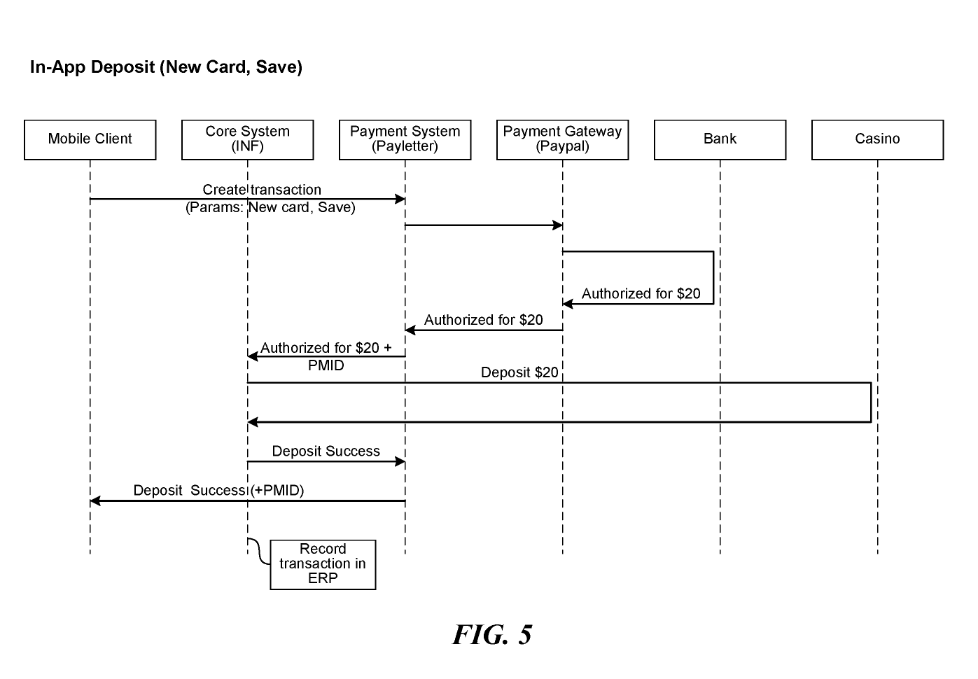

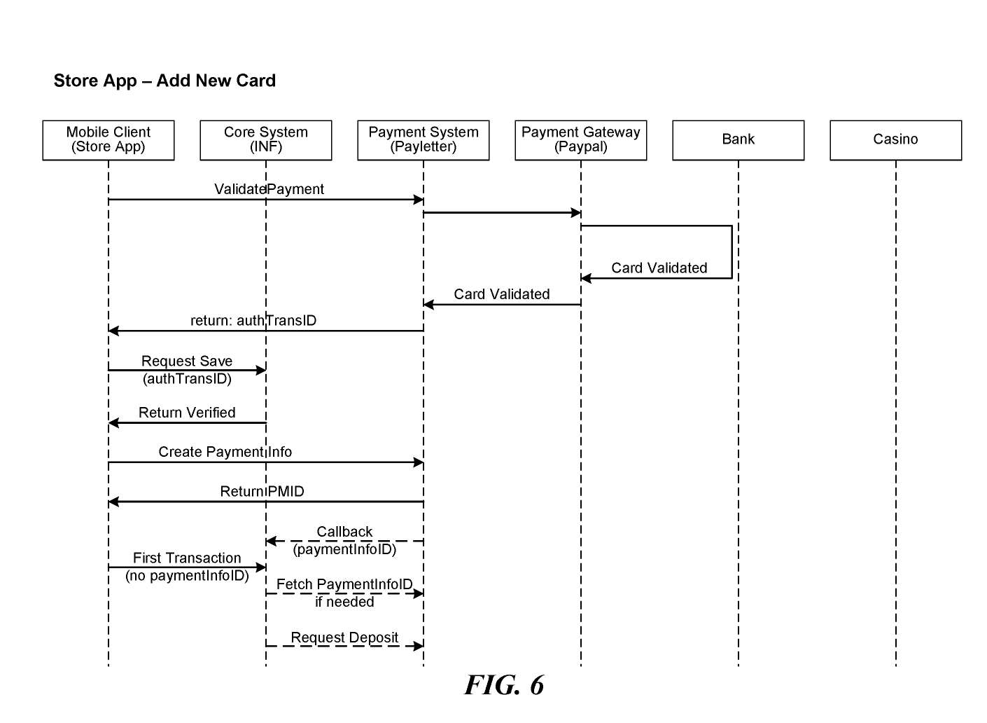

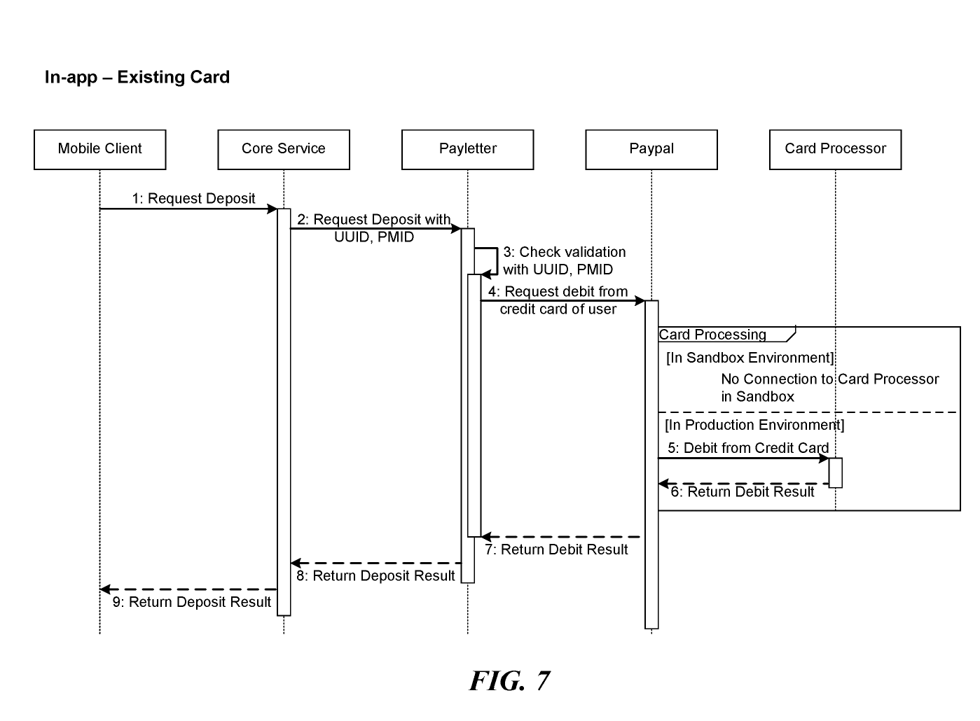

FIGS. 4-7 are sequence diagrams illustrating process flows of methods of operation for various embodiments of the casino marketplace. According to disclosed embodiments, functionalities of the mobile client (SDK), the Core System (INF), and the Payment System (e.g., Payletter) are provided by an entity hosting the application marketplace. The mobile client (SDK) runs on a device of the user such as a smart phone, a tablet, or a wearable electronic device. The Core System and the Payment System run on one or more physical, virtual, or cloud servers hosting the application marketplace. For example, FIG. 4 depicts a sequence of example transactions in connection with an embodiment in which information relating to a user's newly-added financial card (e.g., a credit card or a debit card) is not saved in the user's account (e.g., at the user's mobile device and/or the server). FIG. 5 depicts a sequence of example transactions in connection with an embodiment in which information relating to a user's newly-added financial card (e.g., a credit card or a debit card) is saved in the user's account. FIG. 6 depicts a sequence of example transactions in connection with an embodiment in which information relating to a user's financial card (e.g., a credit card or a debit card) is added to the user's account. FIG. 7 depicts a sequence of example transactions in connection with an embodiment in which information relating to a user's existing financial card (e.g., a credit card or a debit card) is saved in the user's account. In the FIG. 7 embodiment, the processing of the financial card can take place in a secure (e.g., “sandbox”) environment.

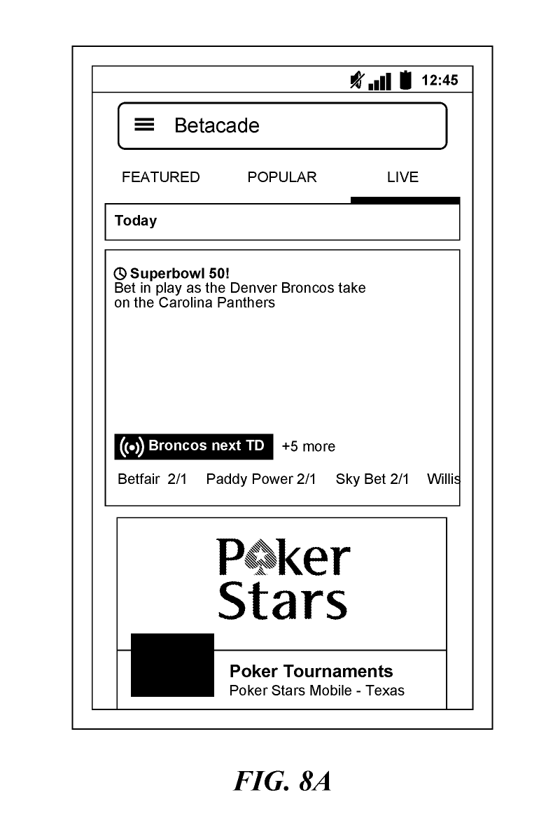

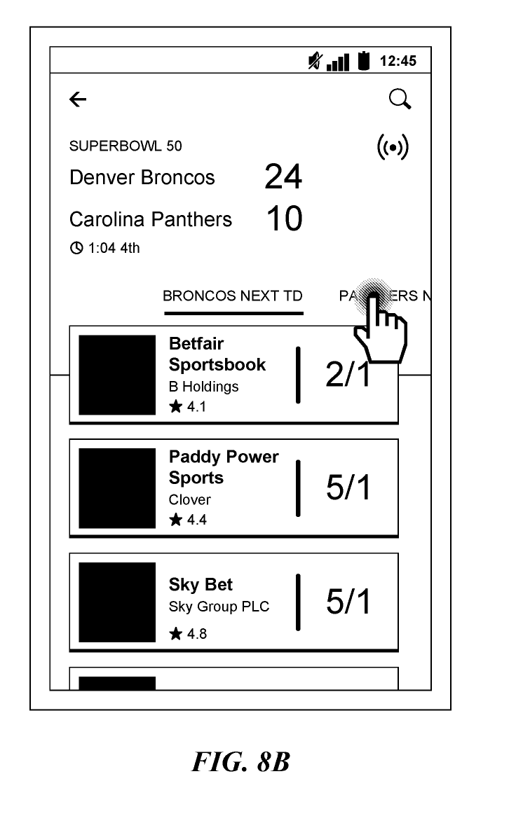

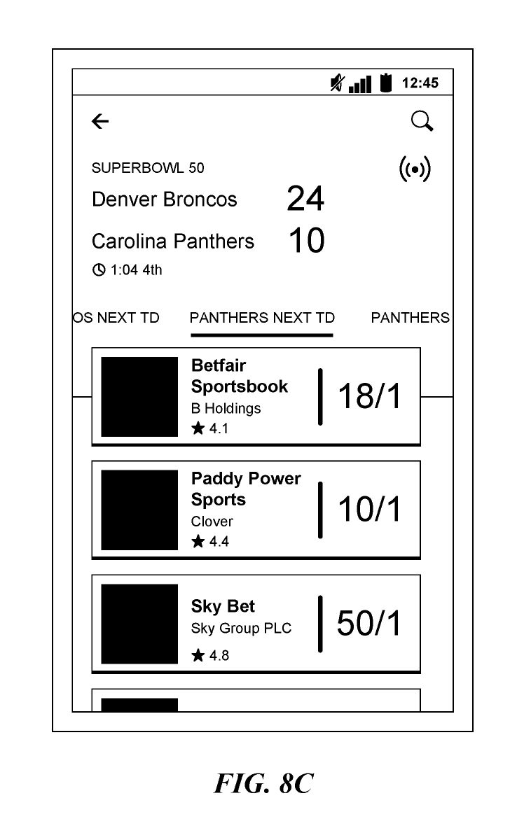

FIGS. 8A-8C are screenshots illustrating betting on real life events in real time. For example, FIGS. 8A-8C show scores in a Superbowl played between the Denver Broncos and the Carolina Panthers. Also shows are various third-party casino applications (available at the casino marketplace) such as “Betf air Sportsbook,” “Paddy Power Sports,” and “Sky Bet”. Examples of real life events include “Panthers Next Touchown,” “Broncos Next Touchdown,” etc. FIGS. 8B and 8C also show the bets associated with these real life events, the bets being offered by the third-party casino applications.

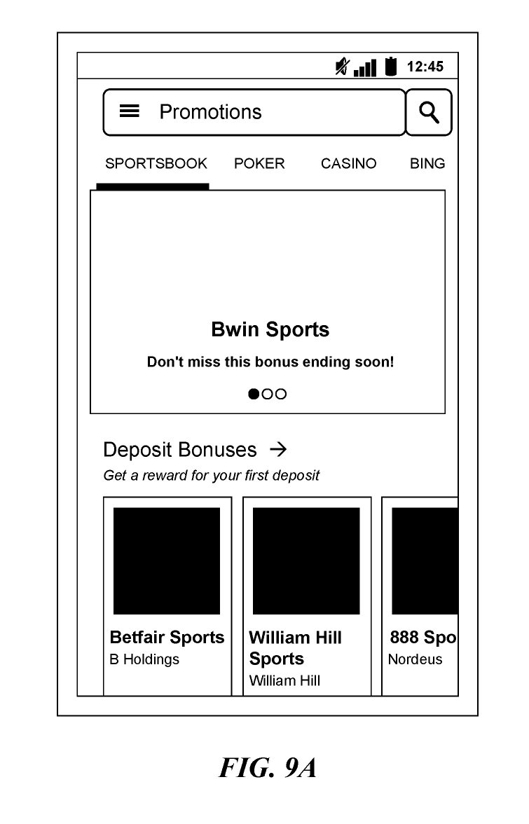

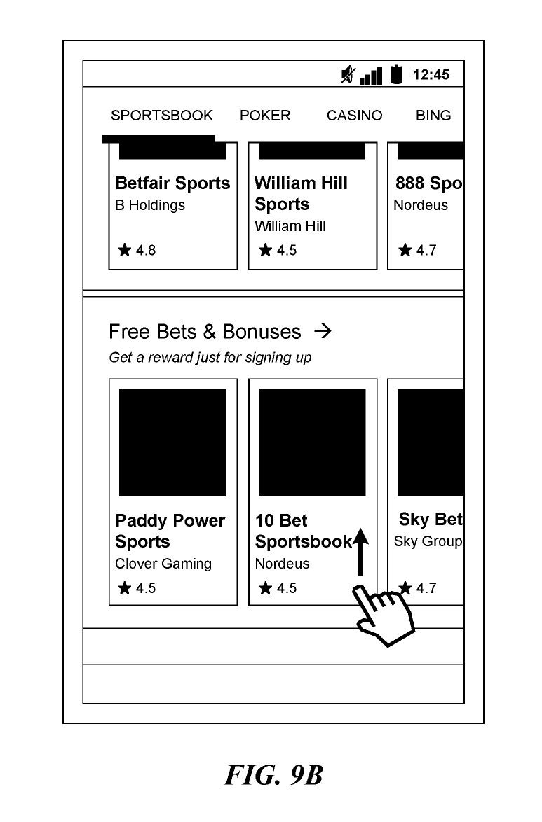

FIGS. 9A and 9B illustrate screenshots showing various segments of the casino marketplace, and promotions associated with these segments. In some embodiments, the disclosed system categorizes casino applications into one or more segments of the casino marketplace. The segments correspond to a category or type of casino application. Examples of such segments are Sportsbook, Poker, Casino, and Bingo. The promotions included in the Sportsbook segment are Deposit Bonuses and Free Bets and Bonuses. In a Deposit Bonus, a user gets a reward for his or her first deposit. In a Free Bets and Bonus, a user gets a reward for signing up with a casino application. Examples of casino applications are Betfair Sports, William Hill Sports, Paddy Power Sports, 10 Bet Sportsbook, etc. In some embodiments, the disclosed system tracks user preferences for certain types of casino applications. Thus, the system can categorize users based on their preferences and offer customized recommendations to the users.

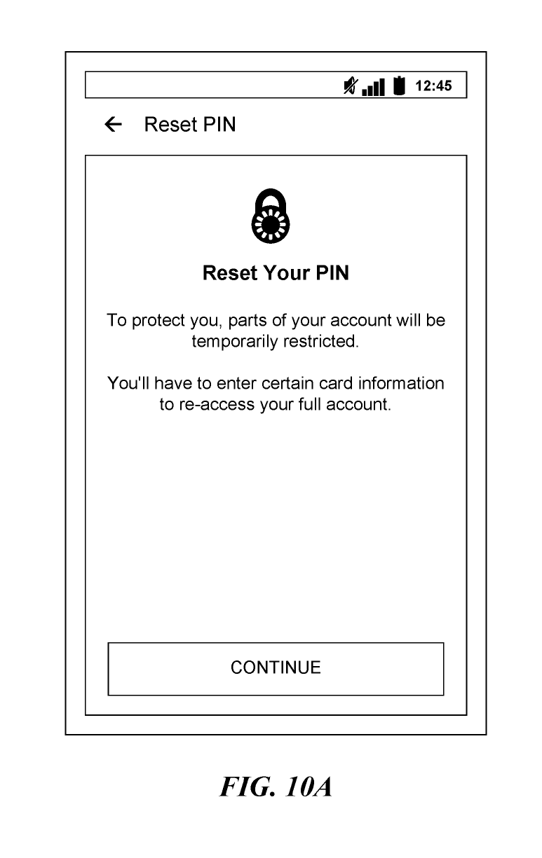

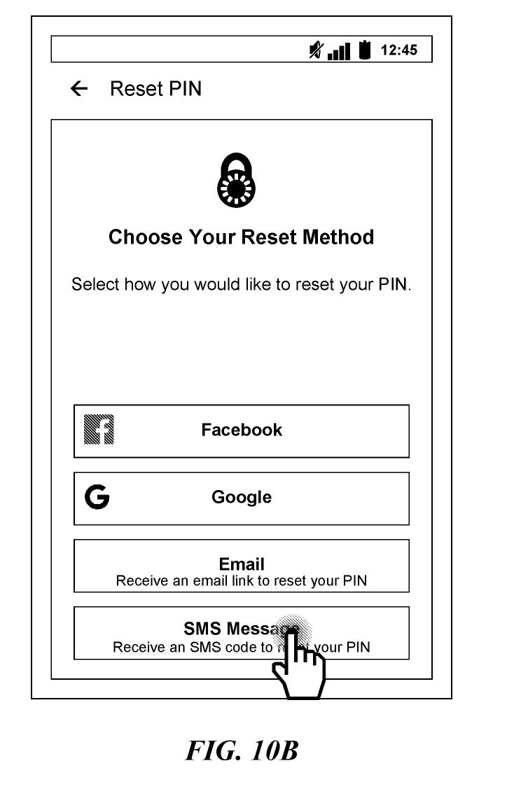

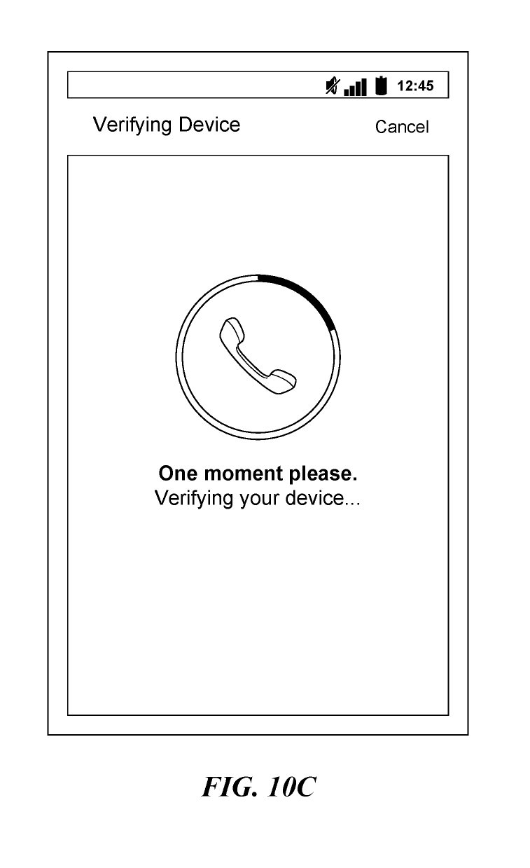

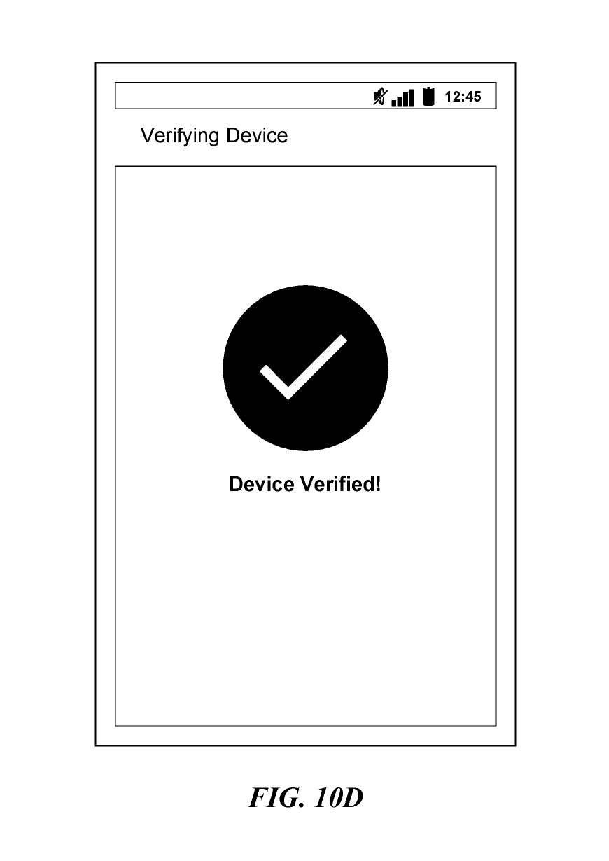

FIGS. 10A-10D illustrate screenshots showing various mechanism of resetting a pin associated with a user's account. For example, a pin can be reset via one or more social media network of the user, an email message including a link, or a text message including a code to reset the pin. The email message or the text message can be sent by a server associated with the casino marketplace. After receiving the text message that includes the code, the user can enter the code via the graphical user interface of the casino marketplace app. Upon receiving the code, the application marketplace verifies the user's device.

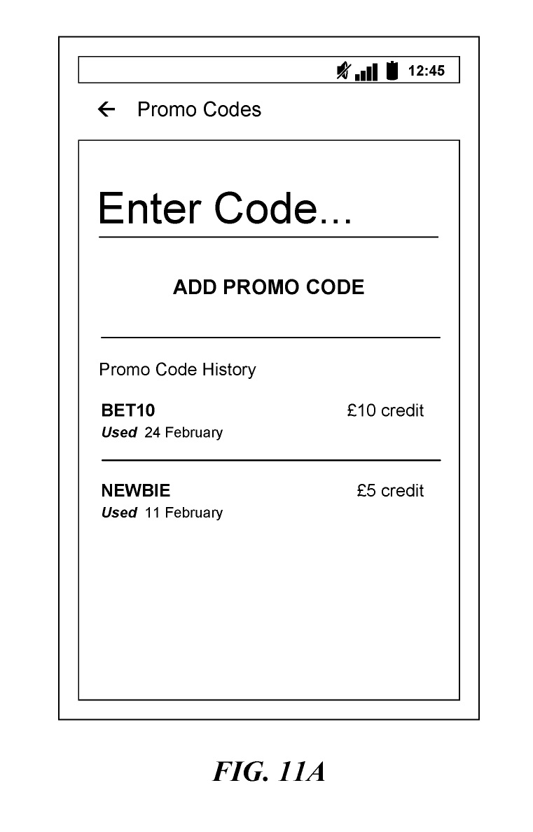

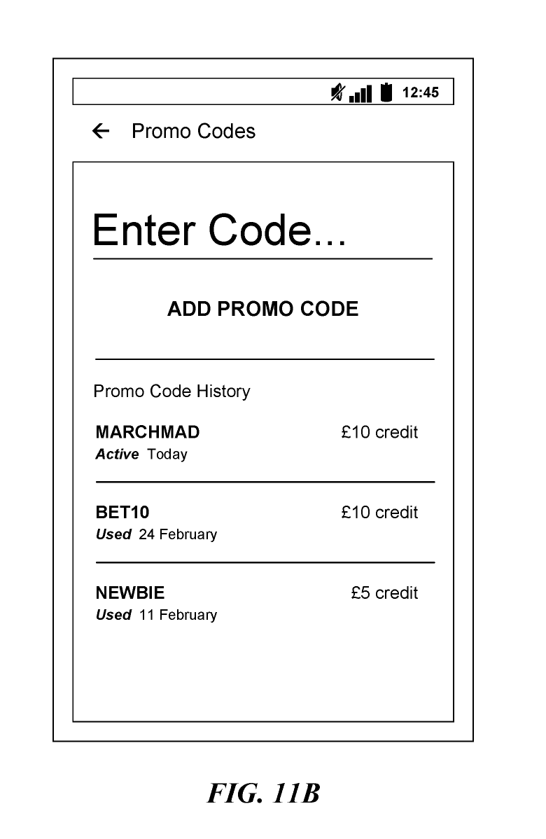

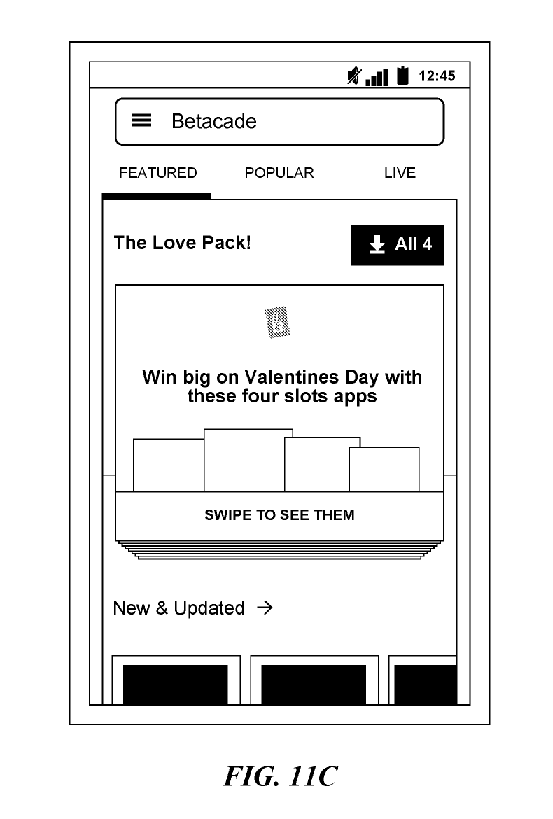

FIGS. 11A-11C illustrate screenshots showing promotion codes for time-based promotions. For example, FIG. 11B indicates that the “MARCHMAD” promotion code is only valid today. FIG. 11C indicates gambling applications (e.g., slots) that are available on Valentine's Day.

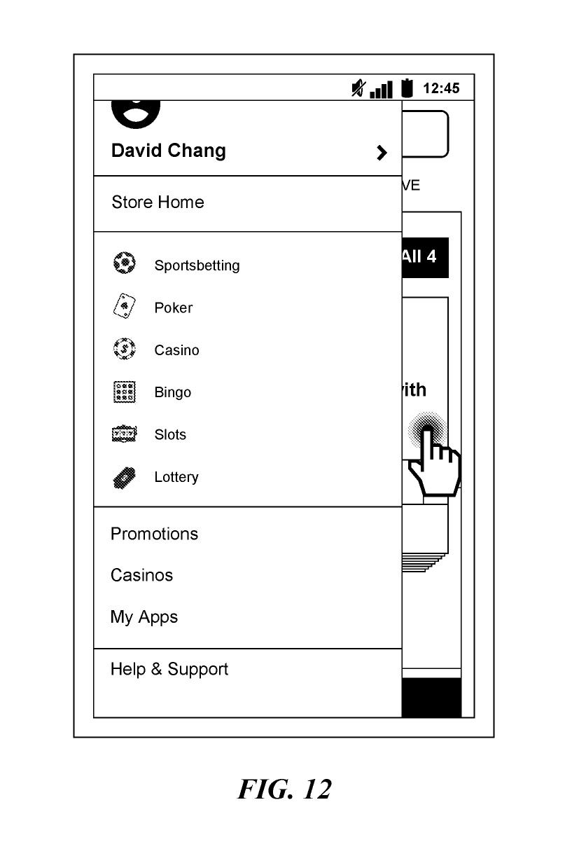

FIG. 12 illustrates a screenshot showing a user's casino marketplace account. For example, a user “David Chang” can download different types of gambling applications from the casino marketplace. Examples of types or segments of gambling applications can be sportsbetting, poker, casino, bingo, slots, and lottery.

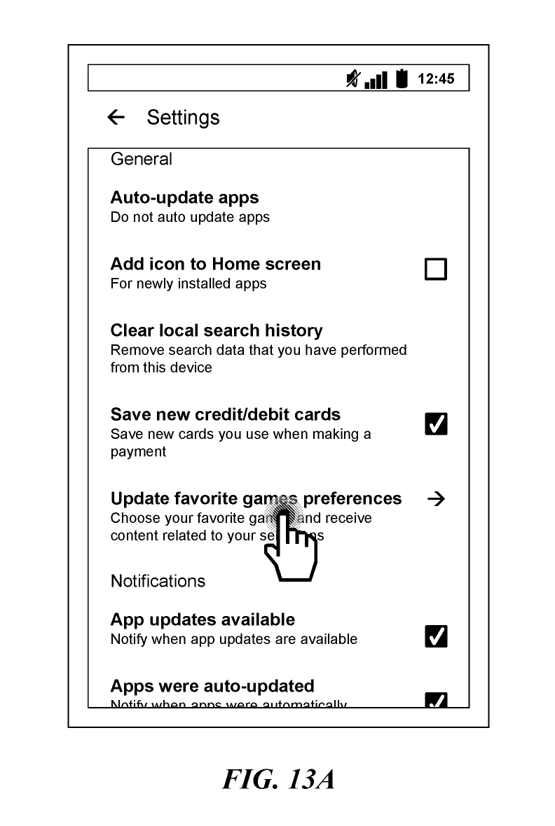

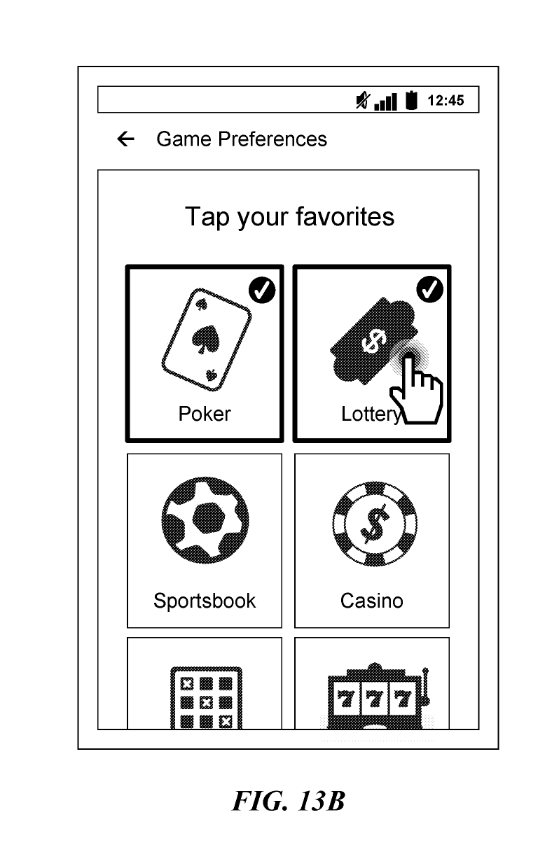

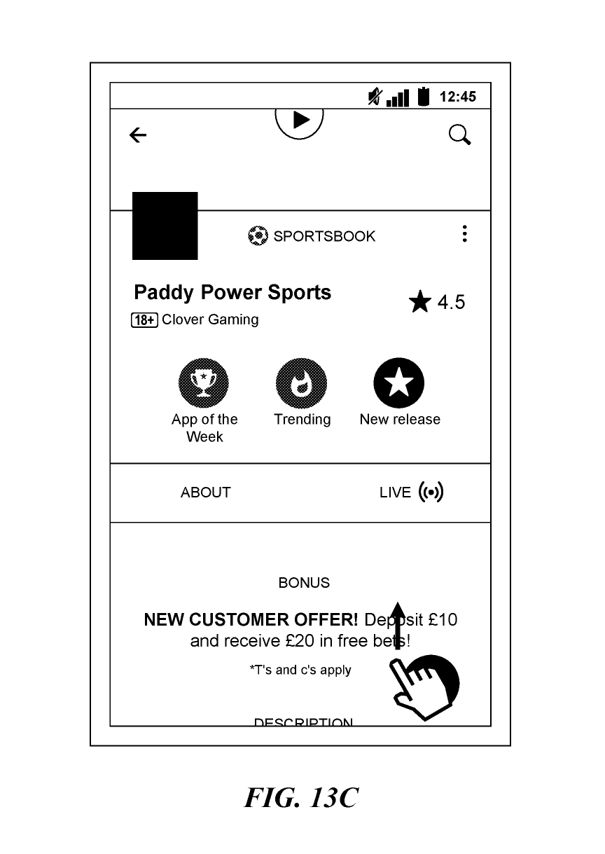

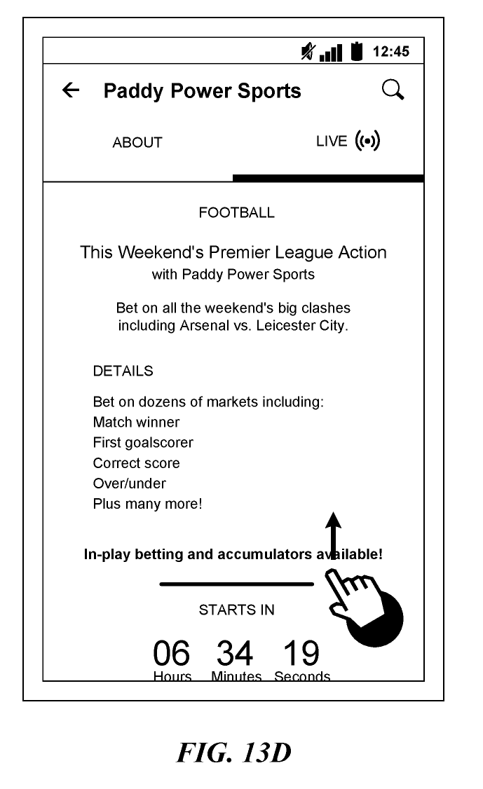

FIGS. 13A-13D illustrate screenshots associated with a user's preferences and casino applications associated with sport events. For example, FIGS. 13A and 13B display game or gambling application preferences of a user. The user can also browse through different sections, with added priority to those categories of applications that the user has elected as favorite categories. FIG. 13C depicts an example promotional offer available to a new customer or user, offered by a casino called “Paddy Power Sports.” In some embodiments, users can rate a casino in the application marketplace. For example, Paddy Power Sports has a user rating of 4.5. FIG. 13D illustrates that Paddy Power Sports provides a sportsbetting application for a weekend soccer match (e.g., Premier League) in which the betting starts in 6 hours 34 minutes 19 seconds according to a system clock running on the application marketplace. Thus, in some embodiments, the application marketplace tracks time and events and notifies a user for promotions, new releases, etc.

### Computer System Overview

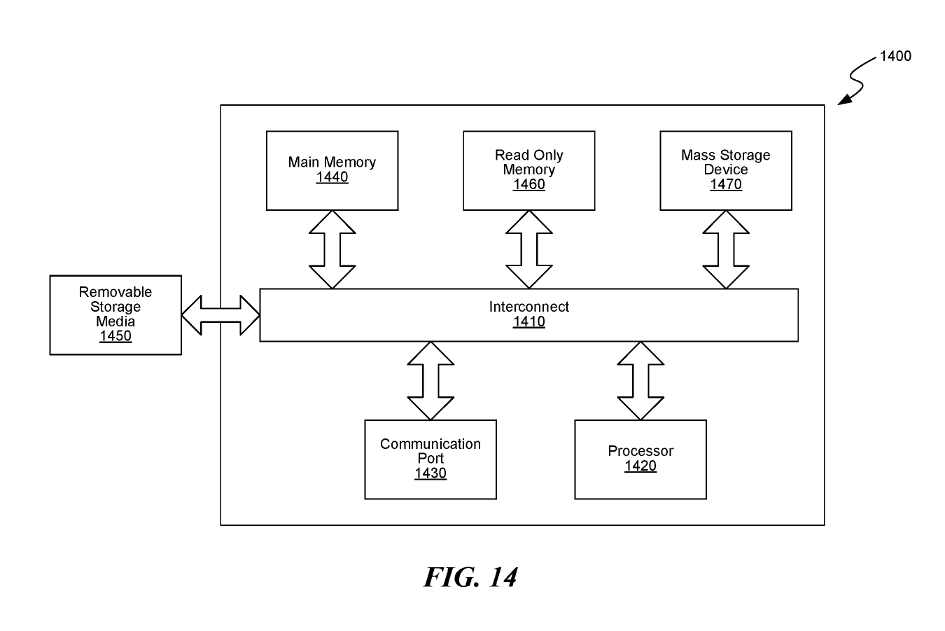

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 14 is an example of a computer system 1400 with which embodiments of the present disclosure may be utilized. According to the present example, the computer system includes an interconnect 1410, at least one processor 1420, at least one communication port 1430, a main memory 1440, a removable storage media 1450, a read only memory 1460, and a mass storage device 1470.

Processor(s) 1420 can be any known processor, such as, but not limited to, an Intel® Itanium® or Itanium 2® processor(s), or AMD® Opteron® or Athlon MP® processor(s), or Motorola® lines of processors. Communication port(s) 1430 can be any of an RS-232 port for use with a modem-based dialup connection, a 10/100 Ethernet port, or a Gigabit port using copper or fiber. Communication port(s) 1430 may be chosen, depending on a network such as a Local Area Network (LAN), Wide Area Network (WAN), or any network to which the computer system 1300 connects.

Main memory 1440 can be Random Access Memory (RAM) or any other dynamic storage device(s) commonly known in the art. Read only memory 1460 can be any static storage device(s) such as Programmable Read Only Memory (PROM) chips for storing static information, such as instructions for processor 1420.

Mass storage 1470 can be used to store information and instructions. For example, hard disks such as the Adaptec® family of SCSI drives, an optical disc, an array of disks such as RAID, the Adaptec family of RAID drives, or any other mass storage devices may be used.

Interconnect 1410 communicatively couples processor(s) 1420 with the other memory, storage, and communication blocks. Interconnect 1410 can be a PCl/PCI-X- or SCSI-based system bus, depending on the storage devices used.

Removable storage media 1450 can be any kind of external hard-drives, floppy drives, IOMEGA® Zip Drives, Compact Disc-Read Only Memory (CD-ROM), Compact Disc-Re-Writable (CD-RW), or Digital Video Disc-Read Only Memory (DVD-ROM).

The components described above are meant to exemplify some types of possibilities. In no way should the aforementioned examples limit the disclosure, as they are only exemplary embodiments.

### Terminology

Brief definitions of terms, abbreviations, and phrases used throughout this application and the appendices are given below.

The terms “connected” or “coupled” and related terms are used in an operational sense and are not necessarily limited to a direct physical connection or coupling. Thus, for example, two devices may be coupled directly or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “embodiments,” and the like generally mean that the particular feature, structure, or characteristic following the phrase is included in at least one embodiment of the present disclosure and may be included in more than one embodiment of the present disclosure. In addition, such phrases do not necessarily refer to the same embodiments or to different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs) interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks, as one skilled in the art will appreciate. As such, the illustrated applications of the embodiments of the present disclosure are not meant to be limiting, but instead are examples. Other systems, devices, and networks to which embodiments of the present disclosure are applicable include, but are not limited to, other types of communication and computer devices and systems. More specifically, embodiments are applicable to communication systems, services, and devices such as cell phone networks and compatible devices. In addition, embodiments are applicable to all levels of computing, from the personal computer to large network mainframes and servers.

In conclusion, the present disclosure discloses novel systems, methods, and arrangements for developing an automated life planner. While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

1. A method comprising:
providing a marketplace application for download and operation on mobile operating platforms, the marketplace application aggregating and managing a plurality of casino applications;
receiving monetary amounts from users;
depositing the monetary amounts into digital wallets associated with the users; and
allowing the users to allocate select deposited monetary amounts to selected casino applications.

2. The method of claim 1, wherein the marketplace application provides promotion codes associated with one or more casino applications in the plurality of casino applications.

3. The method of claim 2, wherein the promotion codes are automatically expire after a length of time.

4. The method of claim 2, wherein the promotion codes are for a specific gambling application in the plurality of casino applications.

5. The method of claim 1, wherein the marketplace application provides selection of one or more casino applications in the plurality of casino applications based on preferences of a user.

6. The method of claim 1, wherein the plurality of casino applications are included in one or more predefined category.

7. The method of claim 6, wherein the one or more predefined category is selected from: new, featured, poker, lottery, sportsbook, casino, slots, and bingo.

8. The method of claim 1, further comprising:
transmitting, via a server, a code to a device of a user for resetting an account of the user.

9. The method of claim 1, wherein a casino application in the plurality of casino applications displays events associated with a sport in real time.

10. The method of claim 1, wherein a casino application in the plurality of casino applications is associated with a future sport event.

11. A method comprising:
providing a marketplace application for download and operation on mobile operating platforms, the marketplace application aggregating and managing a plurality of casino applications;
receiving monetary amounts from users; and
depositing the monetary amounts into digital wallets belonging to users, managed by casinos, and associated with casino applications in use by or designated by users at the time of the deposit.

12. The method of claim 11, wherein the plurality of casino applications are included in one or more predefined category, and the one or more predefined category is selected from: new, featured, poker, lottery, sportsbook, casino, slots, and bingo.

13. The method of claim 11, wherein the plurality of casino applications are included in one or more predefined category, and the one or more predefined category is selected from a list including but not limited to: new, featured, poker, lottery, sportsbook, casino, slots, and bingo.

14. The method of claim 11, wherein a casino application in the plurality of casino applications displays events associated with a promotion, tournament or competition in real time.

15. The method of claim 11, wherein a casino application in the plurality of casino applications is associated with a future promotion, tournament or competition event.

16. The method of claim 11, wherein the receiving and depositing of monetary amounts from users into digital wallets is managed independently of the marketplace by a casino or third party.

17. The method of claim 11, wherein the marketplace displays information associated with a sport event in real time.

18. The method of claim 11, wherein the marketplace displays information associated with a future sport event.

19. The method of claim 11, wherein the marketplace displays information associated with a promotion, tournament or competition in real time.

20. The method of claim 11, wherein the marketplace displays information associated with a future promotion, tournament or competition.

21. A method comprising:
providing a marketplace application for download and operation on mobile operating platforms, the marketplace application aggregating and managing a plurality of casino applications;
marketing a plurality of casino applications on mobile operating platforms; and
receiving compensation from a casino for one or more of: marketing of a casino application within the marketplace, successful installation of a casino application, the activation or reactivation of a user account at the casino, or a share of the revenue generated by the user.

22. The method of claim 21, wherein compensation from the casino is for marketing of a casino application within the marketplace.

23. The method of claim 21, wherein compensation from the casino is for successful installation of a casino application via the marketplace.

24. The method of claim 21, wherein compensation from the casino is for the activation or reactivation of a user account at the casino in relation to the installation of a casino application via the marketplace.

25. The method of claim 21, wherein compensation from the casino is a share of the revenue generated by the user.

26. The method of claim 21, wherein the plurality of casino applications are included in one or more predefined category, and the one or more predefined category is selected from: new, featured, poker, lottery, sportsbook, casino, slots, and bingo.

27. The method of claim 21, wherein the plurality of casino applications are included in one or more predefined category, and the one or more predefined category is selected from a list including but not limited to: new, featured, poker, lottery, sportsbook, casino, slots, and bingo.

28. The method of claim 21, wherein a casino application in the plurality of casino applications displays events associated with a promotion, tournament or competition in real time.

29. The method of claim 21, wherein a casino application in the plurality of casino applications is associated with a future promotion, tournament or competition event.

30. The method of claim 21, wherein the receiving and depositing of monetary amounts from users into digital wallets is managed independently of the marketplace by a casino or third party.

31. The method of claim 21, wherein the marketplace displays information associated with a sport event in real time.

32. The method of claim 21, wherein the marketplace displays information associated with a future sport event.

33. The method of claim 21, wherein the marketplace displays information associated with a promotion, tournament or competition in real time.

34. The method of claim 21, wherein the marketplace displays information associated with a future promotion, tournament or competition.
